(19) United States
(12) Patent Application Publication
(10) Pub. No.: US 2015/0140542 A1
(43) Pub. Date: May 21, 2015

(54) Robotic game system for educational competitions

(71) Applicant: Luke Edward Ward, Kokomo, IN (US)

(72) Inventor: Luke Edward Ward, Kokomo, IN (US)

(73) Assignee: VisualEdge, Inc., Kokomo, IN (US)

(21) Appl. No.: 13/998,653

(22) Filed: Nov. 20, 2013

(51) Int. Cl. G09B 19/00

(52) U.S. Cl. CPC G09B 19/0069
USPC 434/401

(57) ABSTRACT

Robotic game system for education of the electrical, mechanical, design and strategic arts containing elements for robotic remote control and autonomous action in inter-team competitions with illustrative examples of said education materials and components.

### CROSS REFERENCE

This application is a continuation from U.S. Non-provisional application Ser. No. 12/378,640; filed Feb. 18, 2009, which claims the benefit of U.S. Provisional Application No. 61/066,648; filed Feb. 22, 2008, the entirety of both of which are incorporated herein by reference.

### TECHNICAL FIELD

The present disclosure relates generally to a system and method for education of the mechanical and electrical arts through playing games, and more particularly, but not necessarily entirely, to a unique educational gaming concept allowing single or multiple participants to design, build, test, and then compete in robot-based competitions.

### BACKGROUND OF THE INVENTION

In the United States, robotics education is being used to teach the mechanical and electrical arts to students. Sometimes included as part of an industrial arts curriculum, more often schools form teams of motivated students for inter-school competition. Competition levels cover the Middle School, High School and College age and proficiency levels.

Companies such as US FIRST (For Inspiration and Recognition of Science and Technology) and VEX Robotics have respectively launched the FIRST Robotics Competition and the VEX Robotics World Championship Competition allowing educators to use inter-team competition as a motivator for student participation.

While simple, easily constructed games emulating classic pre-school children's toys such as ball collecting, block stacking and terrain obstacle races sufficed to introduce students to robotics and thus the electrical and mechanical arts, these games, and the rigidly specified robotic kits, failed to provide the challenge needed to foster continued student interest and innovation. Additionally, decreasing prices in processors, sensors, actuators and transducers, as well as greater design and programming tools, allow robot platforms to perform more complex tasks which are not encompassed by the present games.

To offer more challenging inter-team gaming, skill development, inclusion of new robotic technologies, and greater student innovation; as well as ease-of-use by the educator; the Game-in-Box™ system was created.

### SUMMARY OF THE INVENTION

The Game-in-a-Box gaming system for education provides instructors and students with the means for development and practice of engineering and technical artsand allows students to gain experience in design, project management, strategy and tactics.

The Game-in-a-Box provides educators and students with electrical and mechanical components, parts lists, educational materials, rules for game play and judging, and robot construction. Software-based design tools, computer-aided-design (CAD) and software-based scoring software may also be included in the documentation package(s).

Rules and examples for game play by remote control, pre-programmed autonomous or even autonomous learning systems are also included allowing instructor customization of the game for student programming skill levels.

Use of common components, development kits, and programming languages levels the differences in school activity funding and maximizes student innovation in development and game play. Use of a common gaming platform allows each team the ability to practice and optimize the robot for competitive play.

### BRIEF DESCRIPTION OF THE DRAWINGS

The foregoing summary, as well as the following detailed description, are better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 depicts the Game-in-a-Box™ concept.

FIG. 2 shows the kit components for the Involution™ game for educational robotics competitions.

FIG. 3 depicts the kit components for the Cone Zone™ game for educational robotics competitions.

### DETAILED DESCRIPTION OF ILLUSTRATIVE EMBODIMENTS

We will now describe illustrative embodiments of the present invention. First, we provide a detailed overview of the problem and then a more detailed description of our solutions.

Development of a robotic competition involving the widest range of schools requires a well devised game for the student built robots to play, either under remote or autonomous control. While many companies offer robotic kits of various complexities and components for robots (sensors, transducers, actuators, controllers, wireless data communications), games for the robot to play are not commonly available.

Wireless data communications encompass digital and analog communications systems, including those using sonic, free space optical (such as infrared) or radio transmissions. Wired data communications encompass digital and analog communications systems including those using electrical or optical signaling over a tether.

A well-designed robotic game requires that a robot can be constructed to accomplish a certain set of tasks using a limited number of components and design tools. The robotics game design must limit the required mechanical, electrical, programming and skill set to the target age of the educational group. The game challenge level must also be regulated in order to interest the widest group of students (and educators), while at the same time it should provide educational opportunities not to exceed the class or extracurricular activity time constraints.

The educational game for robotics competitions must also satisfy competitive contest needs. A clear scoring method and a set game duration must be calculated or derived from extensive testing before a game kit can be issued.

Educators include formal educators as well as mentors or parents interested in leading a competitive robotics team. Students include formal school or ad hoc club members as well as hobbyists and the self-educated. In the case of hobbyists or the self-taught, both the educator and student documentation packages would be of interest and use.

Using a common set of robotic components designed around skill-level appropriate robotics game, packaged with educator and/or student documentation and design software for the various mechanical, electrical and software subsystem of the robot, maximizes the educational value while broadening the student participation.

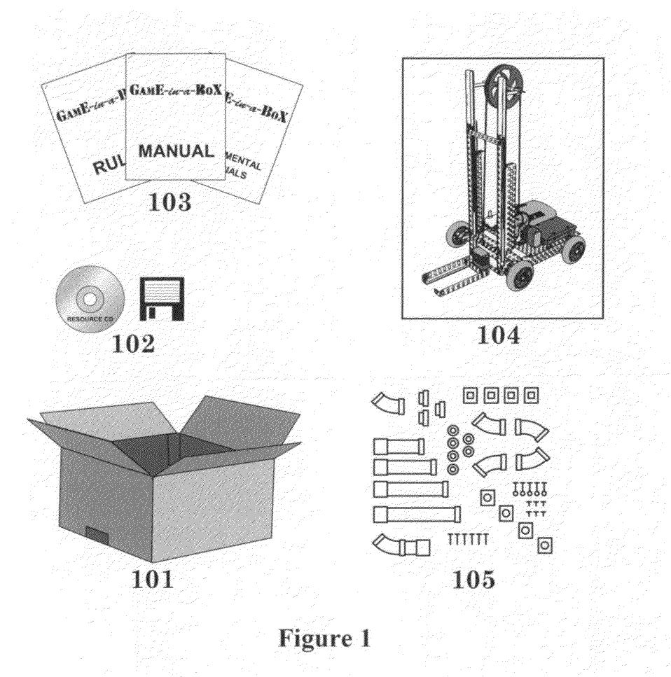

FIG. 1 is used to show the components of a generic Game-in-a-Box educational robotics competition system. The shipping material 101 consists of cardboard, plastic or wooden boxes. The shipping material 101 may be reused to either as part of the game playing field or to store the game between builds. As part of the digital documentation 102 educator, competition, and student documentation 103 are included. A reference design 104 for a robot capable of playing the Game-in-a-Box may also be included. Components for the game 105 are also included in the shipped Game-in-a-Box. The digital documentation 102 software can also include electrical and mechanical arts training materials, sample code, design software, example reference design(s), simulation software, digital documentation, competition rules and/or competition scoring software.

Although the Game-in-the-Box was originally designed to allow construction and competition play of the enclosed game with any robot, a robotic build kit may be included in the Game-in-Box.

### Illustrative Examples

The following examples are meant only to illustrate, but in no way to limit, the present invention.

The Involution™ Game Kit

The Involution™ gaming package was the second robotics gaming system created by VisualEdge™ Inc. The gaming package contains both game materials and documentation for the educator and students.

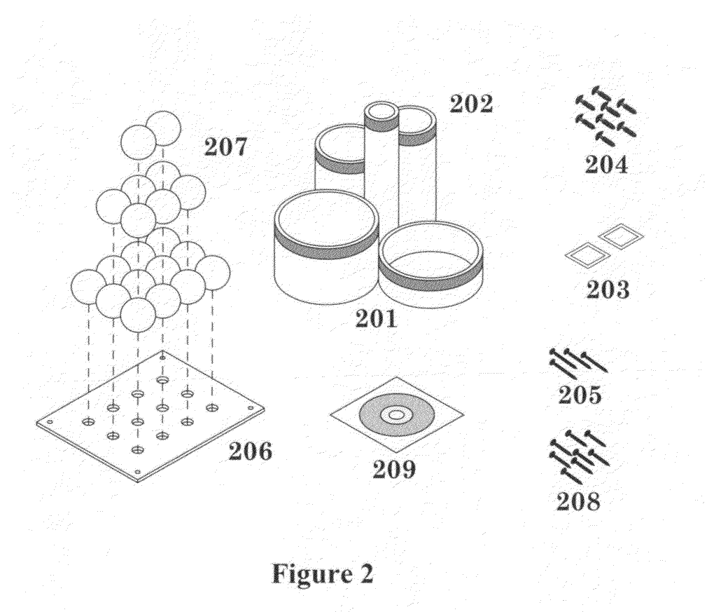

FIG. 2 is used to show the components of the Involution Game-in-a-Box educational robotics competition system. The scoring goal 201 (one of two shown) consists of precut lengths of varied diameter PVC pipe. This goal is color-coded 202 and predrilled and ready to assemble. Cleaning supplies 203 are used to prepare the pipes for assembly and the goal fasteners 204 are used to secure the pieces together. Supplied fasteners 205 are used to secure down the goal assembly. Ball stands 206 (one of two shown) are made from polyethylene plastic sheets and have been predrilled to help arrange the color-coded, scoring balls 207 in a pyramid-like orientation. Supplied fasteners 208 are used to fasten the ball stand 206 to the playing surface. Also included is a Resource CD 209 that has been preloaded with digital documentation, scoring software, seeding match schedules, a tournament bracket, and printable award certificates.

The game documentation on the Involution game Resource CD 209 consists of materials for both the educator and student(s). Documentation includes: (A) Involution Game Instruction Manual, (B) Involution Game Referee Manual, (C) Involution Game Scoring Software, (D) Involution Game Printable Award Certificates and (E) Involution Game Competition Rules.

The Involution Game Instruction Manual provides an overview of the Involution game for both students and educators. This document details the field construction and layout, component assembly and usage, possible game variations, participating team composition, and descriptions of software usage.

The Involution Game Referee Manual provides recommendations and strategies for the aspiring referee. The document explains the role of the referee and their responsibilities.

The Involution Game Scoring Software provides an easy-to-use scoring system to help manage the competition. The software also contains a match schedule for an 8 team or 16 team competition and a tournament bracket. Users may use project this on a screen as a visual reference to all participants.

The Involution Game Competition Rules provides a standard set of rules and regulations that keeps the game fair for all participants. These rules can easily be distributed via electronic or hard copies.

The Involution Game Printable Award Certificates provides the game mentor or organizer the means of acknowledging outstanding performance, sportsmanship, and creativity.

Cone Zone™ Gaming Package

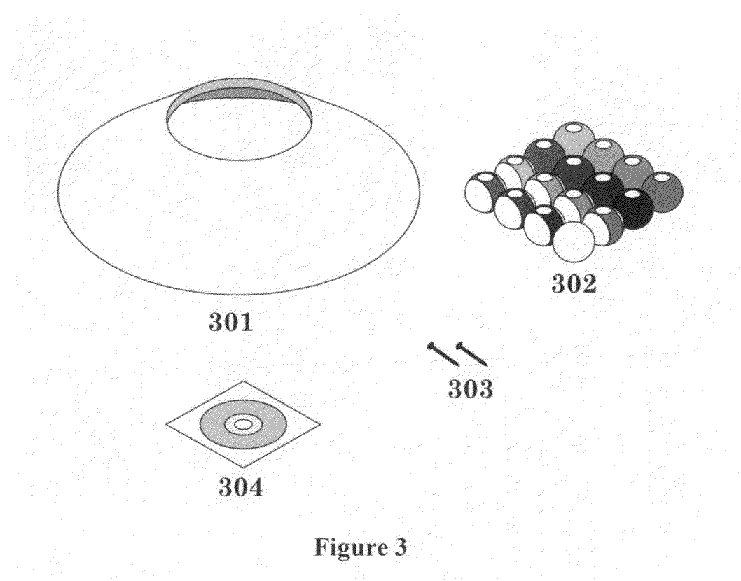

FIG. 3 is used to show the components of a specific Game-in-a-Box educational robotics competition system, the Cone Zone game. The scoring conic 301 has a 20″ diameter at its base and an 8″ hole in the center. It has a 40° incline and is constructed from a durable plastic resin. The scoring components 302 are a standard set of billiard balls. Supplied fasteners 303 are used to secure the scoring goal to the playing field. Also included is the game specific Resource CD 304 that has been preloaded with digital documentation, scoring software, seeding match schedules, a tournament bracket, and printable award certificates.

The game documentation on the Cone Zone Resource CD 304 consists of materials for both the educator and student(s). The Cone Zone Game Instruction Manual provides an overview of the Cone Zone game for both students and educators. This document details the field construction and layout, component, game play rules, game variations, participating team composition, and descriptions of software usage.

The Cone Zone Game Referee Manual provides recommendations and strategies for the aspiring referee. The document explains the role of the referee and their responsibilities.

The Cone Zone Game Scoring Software provides an easy-to-use scoring system to help manage the competition. The software also contains a match schedule for an 8 team or 16 team competition and a tournament bracket. Users may use project this onto a screen as a visual reference for all participants.

The Cone Zone Game Printable Award Certificates provides the game mentor or organizer the means of acknowledging outstanding performance, sportsmanship, and creativity.

### CONCLUSION

The true scope the present invention is not limited to the presently preferred embodiments disclosed herein.

In many cases, the implementation (i.e., the functional element) or inclusion of a component in the game system as described herein is merely a game designer's preference and not a hard requirement. Accordingly, except as they may be expressly so limited, the scope of protection of the following claims is not intended to be limited to the specific embodiments described above.

What is claimed:

1. A system for teaching innovation, engineering and technical skills to at least one participant via refereed, robotic competition based on a game package where said package comprises; a game component kit, and a documentation package for the educator. Wherein said documentation package for the educator includes instructions to referee said robotics competition using a scoring method and set game duration calculated or derived from testing of the game package.

2. The system as in claim 1, wherein said game component kit comprises pre-fabricated parts.

3. The system as in claim 1, wherein said game component kit comprises pre-marked parts for student fabrication.

4. The system as in claim 1, wherein said game component kit comprises a part list for educator acquisition for student fabrication and assembly.

5. The system as in claim 1, wherein said robot competition; comprises use of a robot under remote control via a wireless data link.

6. The system as in claim 1, wherein said robot competition; comprises use of a robot under remote control via a wired data link.

7. The system as in claim 1, wherein said robot competition; comprises use of a robot under pre-programmed autonomous control.

8. The system as in claim 1, wherein said robot competition; comprises use of a robot under self adjusting rules-based autonomous control.

9. The system as in claim 1, wherein said documentation package for the educator; comprises a reference robot design capable of executing tasks required in said robotics competition.

10. The system as in claim 1, wherein said documentation package for the educator; comprises game rules for said robotic competition.

11. The system as in claim 1, wherein said documentation package for the educator; comprising scoring software for said robotic competition.

12. The system as in claim 1, wherein said documentation package for the educator; comprising award certificates for participants in said robotic competition.

13. The system as in claim 1, wherein said documentation package for the educator; comprising educational materials on mechanical and electrical components of robotic systems.

14. The system as in claim 1, wherein said game package; further comprises a student directed documentation package.

15. The system as in claim 1, wherein said student directed documentation package; comprises a game instruction manual.

16. The system as in claim 1, wherein said student directed documentation package; comprises design tools.

17. The system as in claim 1, wherein said student directed documentation package; comprises a reference robot design capable of executing tasks required in said robotics competition.

18. A method for the teaching of innovation and skills in the mechanical and electrical arts to at least one participant via robotic competition; comprising use of challenge levels set by the game, said game comprising of a common set of gaming rules, documentation and game components.

19. A game system for education of the electrical, mechanical, design and strategic arts containing elements for robotic remote control and autonomous action in inter-team competition.
